(19) United States
(12) Patent Application Publication
(10) Pub. No.: US 2026/0362368 A1
(43) Pub. Date: Nov. 12, 2026

(54) ACQUIRING REFERENCE LOCATION OF NTN EARTH-MOVING CELL

(71) Applicant: LG ELECTRONICS INC., Seoul (KR)

(72) Inventors: Han CHA, Seoul (KR); Sunghoon JUNG, Seoul (KR)

(73) Assignee: LG ELECTRONICS INC., Seoul (KR)

(21) Appl. No.: 19/100,278

(22) PCT Filed: Aug. 1, 2023
(86) PCT No.: PCT/KR2023/011227

§ 371 Date: Jan. 31, 2025

Related U.S. Application Data
(60) Provisional application No. 63/395,868, filed on Aug. 8, 2022.

(51) Int. Cl. H04W 64/00; H04B 7/185

(52) U.S. Cl. CPC H04W 64/00; H04B 7/18513

(57) ABSTRACT

A method and apparatus for acquiring reference location of Non-Terrestrial Network (NTN) earth-moving cell. A wireless device receives assistance information from a serving cell. The assistance information includes i) a set of reference locations and ii) time information related to each of the reference locations. The wireless device selects a reference location, from among the set of reference locations, related to a current time based on the time information.

### CROSS-REFERENCE TO RELATED APPLICATIONS

This application is the National Stage filing under 35 U.S.C. 371 of International Application No. PCT/KR2023/011227, filed on Aug. 1, 2023, which claims the benefit of U.S. Provisional Application No. 63/395,868 filed on Aug. 8, 2022, the contents of which are all hereby incorporated by reference herein in their entireties.

### TECHNICAL FIELD

The present disclosure relates to acquiring reference location of Non-Terrestrial Network (NTN) earth-moving cell.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

Non-Terrestrial Network (NTN) is being studied. The basic idea of NTN is to deliver 5G/NR service via space (satellite) or air (airborne platform). If it is realized as expected, it would be able to deliver the 5G service to those places where it is technically very difficult or cost too much to deliver with terrestrial network. Some examples of those places would be a remote area like deep forest that would be too costly with terrestrial delivery, or far islands or ship that would be technically almost forbidden in terrestrial connection.

3GPP Rel-17 specifications will support NR based satellite access deployed in Frequency Range-1 (FR1) bands serving handheld devices for global service continuity. Equally exciting, the 3GPP Rel-17 specification will support Narrowband Internet-of-Things (NB-IoT) and enhanced Machine Type Communications (eMTC) based satellite access to address massive IoT use cases in areas such as agriculture, transport, logistics and many more.

This joint effort between mobile and satellite industries will enable the full integration of satellite in the 3GPP ecosystem and define a global standard for future satellite networks. This will address the challenges of reachability and service continuity in unserved/underserved areas, enhance reliability through connectivity between various access technologies, and improve network resilience and dependability in responding to natural and man-made disasters.

### SUMMARY

In an aspect, a method performed by a wireless device adapted to operate in a wireless communication system is provided. The method comprises receiving assistance information from a serving cell. The assistance information includes i) a set of reference locations and ii) time information related to each of the reference locations. The method comprises selecting a reference location, from among the set of reference locations, related to a current time based on the time information.

In another aspect, an apparatus for implementing the above method is provided.

The present disclosure may have various advantageous effects.

For example, when the Earth-moving cell serves the UE, the UE can acquire the reference location of the Earth-moving serving cell at a specific time.

For example, the UE can conduct the location-based measurement and CHO based on the reference location of the Earth-moving serving cell.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure are applied.

FIG. 2 shows an example of wireless devices to which implementations of the present disclosure are applied.

FIG. 3 shows an example of UE to which implementations of the present disclosure are applied.

FIGS. 4 and 5 show an example of protocol stacks in a 3GPP based wireless communication system to which implementations of the present disclosure are applied.

FIG. 6 shows a frame structure in a 3GPP based wireless communication system to which implementations of the present disclosure are applied.

FIG. 7 shows a data flow example in the 3GPP NR system to which implementations of the present disclosure are applied.

FIG. 8 shows an example of a Non-Terrestrial Network (NTN) to which implementations of the present disclosure are applied.

FIG. 9 shows an example of a method performed by a wireless device to which implementations of the present disclosure are applied.

FIG. 10 shows an example of a method performed by a base station to which implementations of the present disclosure are applied.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in Downlink (DL) and SC-FDMA in Uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

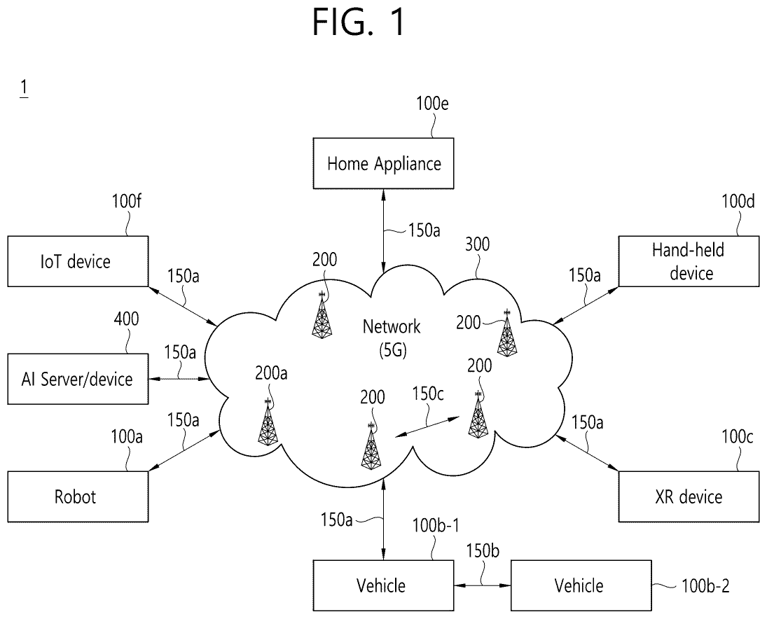

FIG. 1 shows an example of a communication system to which implementations of the present disclosure are applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an eXtended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names.

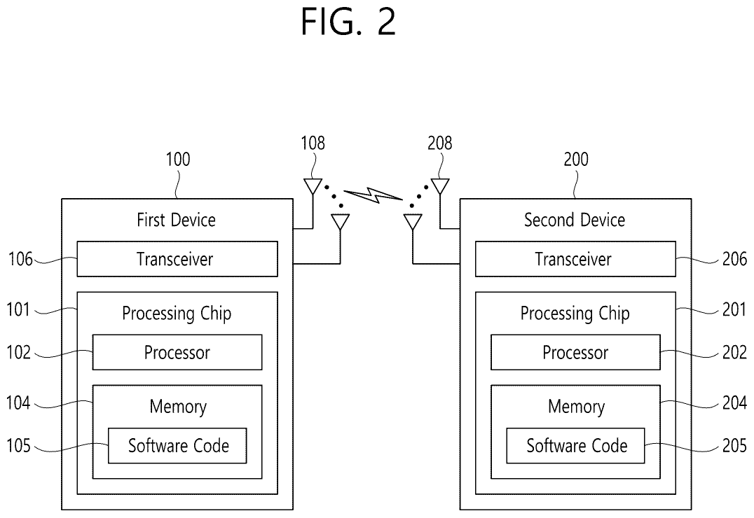

FIG. 2 shows an example of wireless devices to which implementations of the present disclosure are applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in UL and as a receiving device in DL. In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

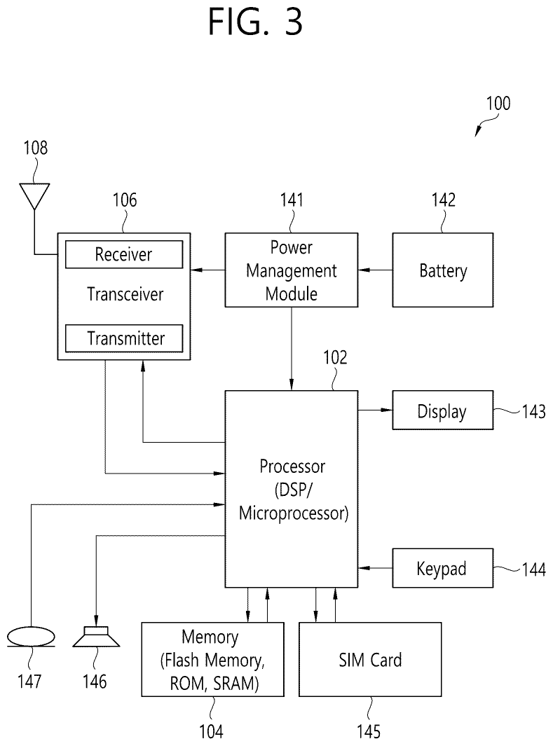

FIG. 3 shows an example of UE to which implementations of the present disclosure are applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

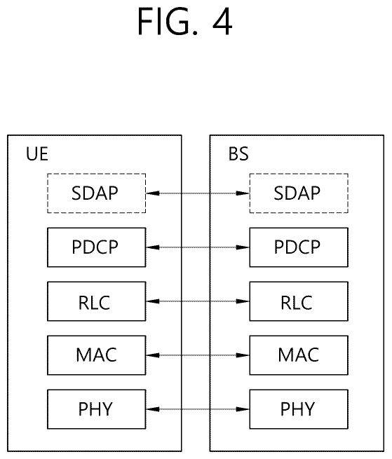

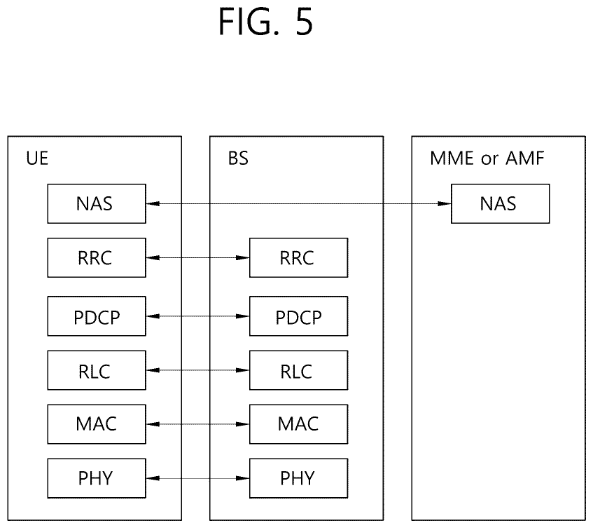

FIGS. 4 and 5 show an example of protocol stacks in a 3GPP based wireless communication system to which implementations of the present disclosure are applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a Non-Access Stratum (NAS) layer. Layer 1, Layer 2 and Layer 3 are referred to as an Access Stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network Quality of Service (QoS) flows.

In the 3GPP NR system, the main services and functions of the MAC sublayer include: mapping between logical channels and transport channels; multiplexing/de-multiplexing of MAC SDUs belonging to one or different logical channels into/from Transport Blocks (TB) delivered to/from the physical layer on transport channels; scheduling information reporting; error correction through Hybrid Automatic Repeat reQuest (HARQ) (one HARQ entity per cell in case of Carrier Aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast Control Channel (BCCH) is a downlink logical channel for broadcasting system control information, Paging Control Channel (PCCH) is a downlink logical channel that transfers paging information, system information change notifications and indications of ongoing Public Warning Service (PWS) broadcasts, Common Control Channel (CCCH) is a logical channel for transmitting control information between UEs and network and used for UEs having no RRC connection with the network, and Dedicated Control Channel (DCCH) is a point-to-point bi-directional logical channel that transmits dedicated control information between a UE and the network and used by UEs having an RRC connection. Dedicated Traffic Channel (DTCH) is a point-to-point logical channel, dedicated to one UE, for the transfer of user information. A DTCH can exist in both uplink and downlink. In downlink, the following connections between logical channels and transport channels exist: BCCH can be mapped to Broadcast Channel (BCH); BCCH can be mapped to Downlink Shared Channel (DL-SCH); PCCH can be mapped to Paging Channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to Uplink Shared Channel (UL-SCH); DCCH can be mapped to UL-SCH; and DTCH can be mapped to UL-SCH.

The RLC sublayer supports three transmission modes: Transparent Mode (TM), Unacknowledged Mode (UM), and Acknowledged Mode (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using Robust Header Compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS Flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5G Core network (5GC) or Next-Generation Radio Access Network (NG-RAN); establishment, maintenance and release of an RRC connection between the UE and NG-RAN; security functions including key management; establishment, configuration, maintenance and release of Signaling Radio Bearers (SRBs) and Data Radio Bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

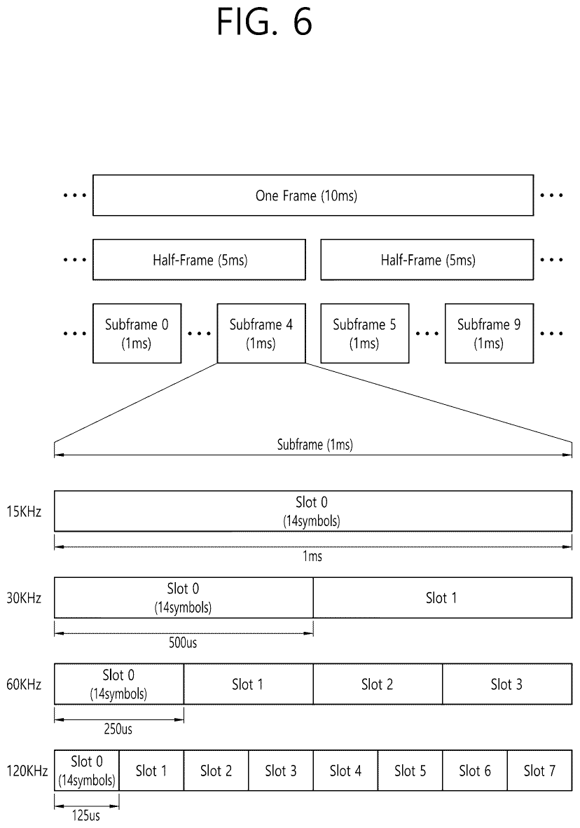

FIG. 6 shows a frame structure in a 3GPP based wireless communication system to which implementations of the present disclosure are applied.

The frame structure shown in FIG. 6 is purely exemplary and the number of subframes, the number of slots, and/or the number of symbols in a frame may be variously changed. In the 3GPP based wireless communication system, OFDM numerologies (e.g., SCS, Transmission Time Interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or Cyclic Prefix (CP)-OFDM symbols), SC-FDMA symbols (or Discrete Fourier Transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a CP. In a normal CP, each slot includes 14 OFDM symbols and, in an extended CP, each slot includes 12 OFDM symbols. The numerology is based on exponentially scalable subcarrier spacing Δf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at Common Resource Block (CRB) N^{start,u}_{grid} indicated by higher-layer signaling (e.g., RRC signaling), where N^{size,u}_{grid,x} is the number of Resource Blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a Resource Element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain.

In the 3GPP NR system, RBs are classified into CRBs and Physical Resource Blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a BandWidth Part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL Component Carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the Primary Cell (PCell). The PCell is a cell, operating on the primary frequency, in which the UE either performs the initial connection establishment procedure or initiates the connection re-establishment procedure. Depending on UE capabilities, Secondary Cells (SCells) can be configured to form together with the PCell a set of serving cells. An SCell is a cell providing additional radio resources on top of Special Cell (SpCell). The configured set of serving cells for a UE therefore always consists of one PCell and one or more SCells. For Dual Connectivity (DC) operation, the term SpCell refers to the PCell of the Master Cell Group (MCG) or the Primary SCell (PSCell) of the Secondary Cell Group (SCG). An SpCell supports Physical Uplink Control Channel (PUCCH) transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

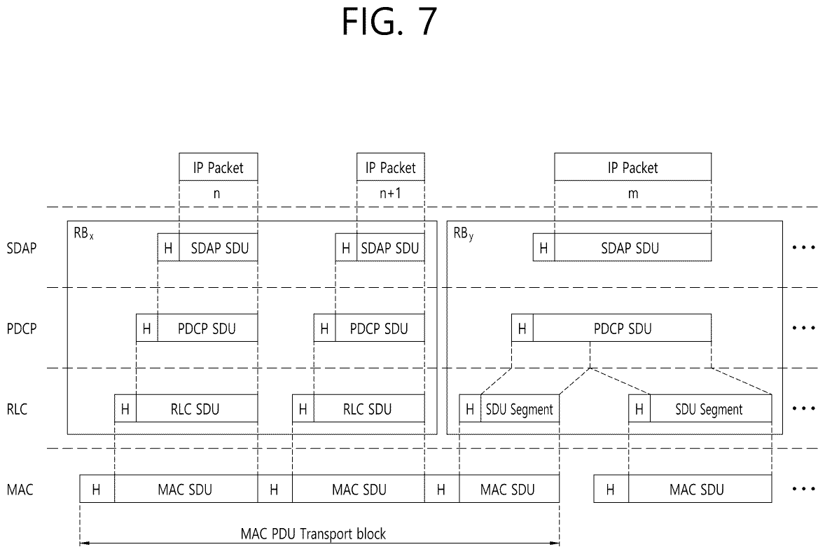

FIG. 7 shows a data flow example in the 3GPP NR system to which implementations of the present disclosure are applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and Random Access Channel (RACH) are mapped to their physical channels Physical Uplink Shared Channel (PUSCH) and Physical Random Access Channel (PRACH), respectively, and the downlink transport channels DL-SCH, BCH and PCH are mapped to Physical Downlink Shared Channel (PDSCH), Physical Broadcast Channel (PBCH) and PDSCH, respectively. In the PHY layer, Uplink Control Information (UCI) is mapped to PUCCH, and Downlink Control Information (DCI) is mapped to Physical Downlink Control Channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

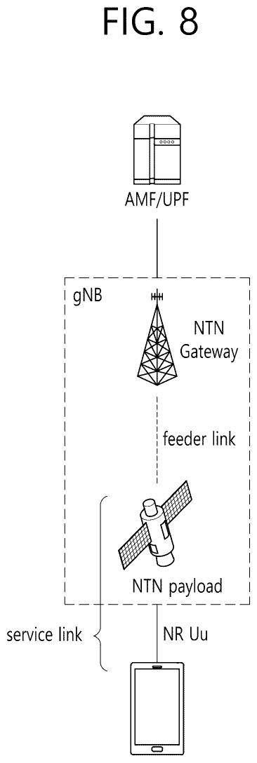

FIG. 8 shows an example of a Non-Terrestrial Network (NTN) to which implementations of the present disclosure are applied.

The NTN provides non-terrestrial NR access to the UE by means of an NTN payload and an NTN Gateway. Referring to FIG. 8, a service link between the NTN payload and a UE, and a feeder link between the NTN Gateway and the NTN payload are described.

The NTN payload transparently forwards the radio protocol received from the UE (via the service link) to the NTN Gateway (via the feeder link) and vice-versa. The following connectivity is supported by the NTN payload:
A gNB may serve multiple NTN payloads;
An NTN payload may be served by multiple gNBs.

The NTN-payload may change the carrier frequency, before re-transmitting it on the service link, and vice versa (respectively on the feeder link).

For NTN, the following network identities (IDs) are further applied.
A Tracking Area (TA) corresponds to a fixed geographical area. Any respective mapping is configured in the RAN;
A mapped cell ID

Non-Geosynchronous Orbit (NGSO) includes Low Earth Orbit (LEO) at altitude approximately between 300 km and 1500 km and Medium Earth Orbit (MEO) at altitude approximately between 7000 km and 25000 km.

Three types of service links are supported:
Earth-fixed: provisioned by beam(s) continuously covering the same geographical areas all the time (e.g., the case of Geosynchronous Orbit (GSO) satellites);
Quasi-Earth-fixed: provisioned by beam(s) covering one geographic area for a limited period and a different geographic area during another period (e.g., the case of NGSO satellites generating steerable beams);
Earth-moving: provisioned by beam(s) whose coverage area slides over the Earth surface (e.g., the case of NGSO satellites generating fixed or non-steerable beams).

With NGSO satellites, the gNB may provide either quasi-Earth-fixed cell coverage or Earth-moving cell coverage, while gNB operating with GSO satellite may provide Earth-fixed cell coverage.

In the case of NGSO, service link switch refers to a change of serving satellite.

For measurements in NTN, the network may configure:
multiple Synchronization Signal Block (SSB) Measurement Timing Configurations (SMTCs) in parallel per carrier and for a given set of cells depending on UE capabilities using propagation delay difference and ephemeris information;
measurement gaps based on multiple SMTC.

The adjustment of SMTCs is possible under network control based on UE assistance information if available for connected mode and under UE control based on UE location and satellite assistance information (e.g., ephemeris, common TA parameters) for idle/inactive modes.

The UE may report service link propagation delay differences between service cell and neighbor cells as the assistance information for the adjustment of SMTCs in connected mode.

In the quasi-earth fixed cell scenario, the UE may perform time-based and location-based measurement in RRC_IDLE/RRC_INACTIVE.
The timing and location information associated to a cell are provided via system information;
Timing information refers to the time when the serving cell is going to stop serving a geographical area;
Location information refers to the reference location of serving cell.

Table 5 shows an example of System Information Block type-19 (SIB19). SIB19 may contain satellite assistance information, such as the timing information and the location information mentioned above.

TABLE 5
-- ASN1START
-- TAG-SIB19-START
SIB19-r17 ::= SEQUENCE {

| | | |
|---|---|---|
| ntn-Config-r17 | NTN-Config-r17 | OPTIONAL, -- Need R |
| t-Service-r17 | INTEGER (0..549755813887) | OPTIONAL, -- Need R |
| referenceLocation-r17 | ReferenceLocation-r17 | OPTIONAL, -- Need R |
| distanceThresh-r17 | INTEGER(0..65525) | OPTIONAL, -- Need R |

```
  ntn-NeighCellConfigList-r17 NTN-NeighCellConfigList-r17 OPTIONAL, --
Need R
  lateNonCriticalExtension OCTET STRING OPTIONAL,
  ...
}
NTN-NeighCellConfigList-r17 ::= SEQUENCE (SIZE(1..maxCellNTN)) OF NTN-
NeighCellConfig-r17
NTN-NeighCellConfig-r17 ::= SEQUENCE {
```

| | | |
|---|---|---|
| ntn-Config-r17 | NTN-Config-r17 | OPTIONAL, -- Need R |
| carrierFreq-r17 | ARFCN-ValueNR | OPTIONAL, -- Need R |
| physCellId-r17 | PhysCellId | OPTIONAL -- Need R |

}
-- TAG-SIB19-STOP
-- ASN1STOP

Referring Table 5, the following parameters and/or fields may be defined in SIB 19.
distanceThresh: Distance from the serving cell reference location and is used in location-based measurement initiation in RRC_IDLE and/or RRC_INACTIVE. Each step represents 50 m.
ntn-Config: Provides parameters needed for the UE to access NR via NTN access such as Ephemeris data, common TA parameters, k_offset, validity duration for UL sync information and epoch. The validity duration, ntn-UlSyncValidityDuration, is mandatory present.
ntn-NeighCellConfigList: Provides a list of NTN neighbor cells including their ntn-Config, carrier frequency and PhysCellId.
referenceLocation: This field may correspond to the location information described above. This field indicates reference location of the serving cell provided via NTN quasi-Earth fixed system and is used in location-based measurement initiation in RRC_IDLE and RRC_INACTIVE.
t-Service: This field may correspond to the timing information described above. This field Indicates the time information on when a cell provided via NTN quasi-Earth fixed system is going to stop serving the area it is currently covering. The field indicates a time in multiples of 10 ms after 00:00:00 on Gregorian calendar date 1 January, 1900 (midnight between Sunday, Dec. 31, 1899 and Monday, Jan. 1, 1900). This field is excluded when determining changes in system information, i.e., changes of t-Service should neither result in system information change notifications nor in a modification of valueTag in SIB1. The exact stop time is between the time indicated by the value of this field minus 1 and the time indicated by the value of this field.

Table 6 shows an example of Information Element (IE) referenceLocation. The IE ReferenceLocation contains location information used as a reference location. The value of the field is same as Ellipsoid-Point. The first/leftmost bit of the first octet contains the most significant bit.

TABLE 6

-- ASN1START
-- TAG-REFERENCELOCATION-START
ReferenceLocation-r17 ::= OCTET STRING
-- TAG-REFERENCELOCATION-STOP
-- ASN1STOP

Table 7 shows an example of IE Ellipsoid-Point. The IE Ellipsoid-Point is used to describe a geographic shape.

TABLE 7

| -- ASN1START | |
|---|---|
| Ellipsoid-Point ::= SEQUENCE { | |
| latitudeSign | ENUMERATED {north, south}, |
| degreesLatitude | INTEGER (0..8388607), |
| -- 23 bit field | |
| degreesLongitude | INTEGER (−8388608..8388607) |

-- 24 bit field
}
-- ASN1STOP

Referring to Table 7, the following parameters and/or fields may be defined in the IE Ellipsoid-Point.
latitudeSign: Informs whether a latitude of the corresponding reference location is north latitude or south latitude;
degreesLatitude: informs a degree of latitude of the corresponding reference location;
degreesLongitude: informs a degree of longitude of the corresponding reference location.

Table 8 shows an example of IE ntn-Config. The IE NTN-Config provides parameters needed for the UE to access NR via NTN access.

TABLE 8
-- ASN1START
-- TAG-NTN-CONFIG-START
NTN-Config-r17 ::= SEQUENCE {

| | | |
|---|---|---|
| epochTime-r17 | EpochTime-r17 | OPTIONAL, -- Need R |

ntn-UlSyncValidityDuration-r17 ENUMERATED{ s5, s10, s15, s20, s25, s30, s35,
s40, s45, s50, s55, s60, s120, s180, s240, s900} OPTIONAL, -- Need R

| cellSpecificKoffset-r17 | INTEGER(1..1023) | OPTIONAL, -- Need R |
|---|---|---|
| kmac-r17 | INTEGER(1..512) | OPTIONAL, -- Need R |
| ta-Info-r17 | TA-Info-r17 | OPTIONAL, -- Need R |
| ntn-PolarizationDL-r17 | ENUMERATED {rhcp, lhcp, linear} OPTIONAL, -- Need R | |
| ntn-PolarizationUL-r17 | ENUMERATED {rhcp, lhcp, linear} OPTIONAL, -- Need R | |
| ephemerisInfo-r17 | EphemerisInfo-r17 | OPTIONAL, -- Need R |
| ta-Report-r17 | ENUMERATED {enabled} | OPTIONAL, -- Need R |

...
}
EpochTime-r17 ::= SEQUENCE {

| | |
|---|---|
| sfn-r17 | INTEGER(0..1023), |
| subFrameNR-r17 | INTEGER(0..9) |

}
TA-Info-r17 ::= SEQUENCE {

| ta-Common-r17 | INTEGER(0..66485757), | |
|---|---|---|
| ta-CommonDrift-r17 | INTEGER(−257303..257303) | OPTIONAL, -- Need R |
| ta-CommonDriftVariant-r17 | INTEGER(0..28949) | OPTIONAL -- Need R |

}
-- TAG-NTN-CONFIG-STOP
-- ASN1STOP

Referring Table 8, the following parameters and/or fields may be defined in the IE ntn-Config.
EphemerisInfo: This field provides satellite ephemeris either in format of position and velocity state vector or in format of orbital parameters. This field is excluded when determining changes in system information, i.e., changes of EphemerisInfo should neither result in system information change notifications nor in a modification of valueTag in SIB1.
epochTime: Indicate the epoch time for assistance information (i.e., Serving satellite ephemeris in IE ephemerisInfo and Common TA parameters). When explicitly provided through SIB, or through dedicated signaling, EpochTime is the starting time of a DL subframe, indicated by a System Frame Number (SFN) and a subframe number signaled together with the assistance information. The reference point for epoch time of the serving satellite ephemeris and Common TA parameters is the UL time synchronization reference point. If this field is absent, the epoch time is the end of SI window where this SIB19 is scheduled. This field is mandatory present when provided in dedicated configuration. If this field is absent in ntn-Config provided via NTN-NeighCellConfig, the UE uses epoch time from the serving satellite ephemeris. In case of handover, this field is based on the timing of the target cell, i.e., the SFN and subframe number indicated in this field refers to the SFN and subframe of the target cell. This field is excluded when determining changes in system information, i.e., changes of epochTime should neither result in system information change notifications nor in a modification of valueTag in SIB1.
cellSpecificKoffset: The CellSpecific_K_offset is a scheduling offset used for the timing relationships that need to be modified for NTN. The unit of K_offset is number of slots for a given subcarrier spacing of 15 kHz. If the field is absent UE assumes value 0.
kmac: K_mac is a scheduling offset provided by network if DL and UL frame timing are not aligned at gNB. It is needed for UE action and assumption on DL configuration indicated by a MAC-CE command in PDSCH. If the field is absent UE assumes value 0. For the reference subcarrier spacing value for the unit of K_mac in FR1, a value of 15 kHz is used. The unit of K_mac is number of slots for a given subcarrier spacing.
ntn-PolarizationDL: If present, this parameter indicates polarization information for DL transmission on service link, including Right Hand Circular Polarization (RHCP), Left Hand Circular Polarization (LHCP) and Linear polarization.
ntn-PolarizationUL: If present, this parameter indicates Polarization information for UL service link. If not present and ntnPolarizationDL is present, UE assumes a same polarization for UL and DL.
ntn-UlSyncValidityDuration: A validity duration configured by the network for UL synchronization assistance information (i.e., Serving satellite ephemeris and Common TA parameters) which indicates the maximum time during which the UE can apply assistance information without having acquired new assistance information. The unit of ntn-UlSyncValidityDuration is second. This parameter applies to both connected and idle mode UEs. This field is excluded when determining changes in system information, i.e., changes of ntn-UlSyncValidityDuration should neither result in system information change notifications nor in a modification of valueTag in SIB1. ntn-UlSyncValidityDuration is only updated when at least one of epochTime, ta-Info, ephemerisInfo is updated.
ta-Common: ta-Common is a network-controlled common timing advanced value and it may include any timing offset considered necessary by the network. ta-Common with value of 0 is supported. The granularity of ta-Common is 4.072×10\hat{ }(−3) ρs. Values are given in unit of corresponding granularity. This field is excluded when determining changes in system information, i.e., changes of ta-Common should neither result in system information change notifications nor in a modification of valueTag in SIB1.
ta-CommonDrift: Indicate drift rate of the common TA. The granularity of TACommonDrift is 0.2×10\hat{ }(−3) μs/s. Values are given in unit of corresponding granularity. This field is excluded when determining changes in system information, i.e., changes of ta-CommonDrift should neither result in system information change notifications nor in a modification of valueTag in SIB1.
ta-CommonDriftVariant: Indicate drift rate variation of the common TA. The granularity of TACommonDriftVariation is 0.2×10\hat{ }(−4) μs/s\hat{ }2. Values are given in unit of corresponding granularity. This field is excluded when determining changes in system information, i.e., changes of ta-CommonDriftVariant should neither result in system information change notifications nor in a modification of valueTag in SIB1.

In NTN, the UE and BS communicate with each other via satellites. NTN has been standardized in 3GPP Rel-17 considering GSO and NSGO. NGSO may be LEO. In particular, cells implemented via LEO satellites may be divided into quasi-Earth fixed cells, which are fixed to the ground for a period of time, and Earth-moving cells, which move along the ground. Among these two scenarios, NTN in 3GPP Rel-17 focuses on the quasi-Earth fixed cell scenario for standardization.

Meanwhile, as the NTN cell is deployed to the satellite, the radio quality of the NTN cell measured by the UE at the cell edge may be slightly different from the radio quality at the cell center. Due to this fact, it may be difficult for the UE to notice whether it locates at the cell edge or not by the radio quality measurement. To address this problem, it has been studied to introduce a location-based measurement rule and location-based CHO event enhancement in 3GPP Rel-17.

For location-based measurement, the UE may notice whether it locates at the cell edge or not by comparing the distance from a cell reference location and the distance threshold broadcast by the network. In other words, the network provides the cell reference location to the UE, and if the UE is more than a certain distance away from the cell reference location, the UE may start to perform neighbor cell measurements.

For location-based CHO event enhancement, the network may configure the distance thresholds regarding the distances to the serving cell and target cell from the UE. The UE may acquire the reference location via system information.

As mentioned above, standardization of NTN in 3GPP Rel-17 focuses on GSO and the quasi-Earth fixed cell for NGSO. Common aspect of GSO and the quasi-Earth fixed cell for NGSO is that they cover a fixed geographic area. Therefore, the Earth-fixed cell for GSO and the quasi-Earth fixed cell for NGSO provides a single geographic coordinate for the cell reference location.

On the other hand, as the reference location of Earth-moving cell changes over time, the UE cannot use the reference location of the quasi-Earth fixed cell which indicates a single geographic coordinate. The UE does not have accurate reference location information of the Earth-moving cell, so it is not possible to perform location-based measurement introduced in 3GPP Rel-17.

In order to acquire accurate reference location of the quasi-Earth fixed cell, the UE may frequently acquire the SIB to update the reference location of the Earth-moving cell. However, it may take excessive power consumption for the UE. Furthermore, frequent SIB acquisition may not provide accurate reference location to the UE.

According to embodiments of the present disclosure, the network may provide a set of reference locations and time information related to each of the reference locations to the UE. In this case, the serving cell may be the Earth-moving cell. Based on the set of reference locations and time information related to each of the reference locations, the UE may utilize the element of the set of reference locations for evaluating the location-based measurement and Conditional Handover (CHO).

According to embodiments of the present disclosure, in order to inform the UE of reference location of the Earth-moving cell which varies in time, the network may broadcast multiple reference locations and the time zone in which each reference location is valid. Based on this information, the UE may obtain the reference location of the Earth-moving cell at a specific time.

For example, the network may provide a set of reference locations, epoch time of each of the reference locations and a valid duration. The UE may select the N-th element of the set as a reference location at the time (epoch time+(N−1)*valid duration).

For example, the network may provide a set of reference locations, epoch time of each of the reference locations and a valid duration. The UE may autonomously calculate the reference location of the Earth-moving cell by interpolation between two reference locations provided by the network.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

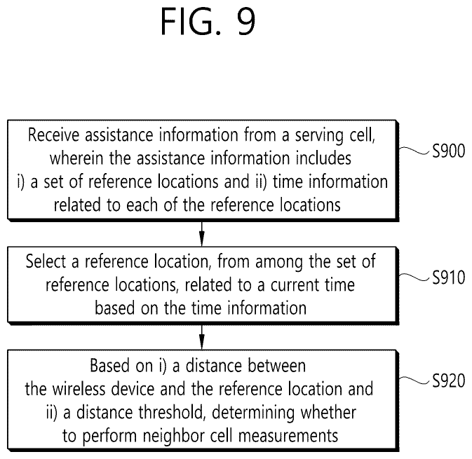

FIG. 9 shows an example of a method performed by a wireless device to which implementations of the present disclosure are applied.

In step S900, the method comprises receiving assistance information from a serving cell. The assistance information includes i) a set of reference locations and ii) time information related to each of the reference locations.

In some implementations, the serving cell may be an Earth-moving cell in NTN.

In some implementations, the assistance information may be received per cell. The assistance information may be received via system information containing satellite information for the Earth-moving cell. For example, the assistance information may be received via new system information which defines satellite information for the Earth-moving cell.

In some implementations, the set of reference locations may include N number of reference locations (e.g., reference location 1, reference location 2 . . . reference location N). The reference locations in the set may be sequential in temporal order. Each of the reference locations may have a form of the field same as Ellipsoid-Point, which is described in Table 7 above. For example, each of the reference locations may include at least one of latitudeSign field, degreesLatitude field and/or degreesLongitude field.

In some implementations, the time information related to each of the reference locations may include at least one of an epoch time of each of the reference locations and/or a valid duration.

In some implementations, the epoch time of each of the reference locations may be provided/represented by an absolute time point (e.g., Universal Time Coordinated (UTC)). The absolute time point may inform when each of the reference locations starts to be valid. The absolute time point may be determined by the same as epochTime, which is described in Table 8 above. For example, the absolute time point may be determined based on an epochTime field, which informs a starting time of a DL subframe indicated by SFN and subframe number. After the absolute time point, the wireless device may select one reference location from the set of reference locations.

In some implementations, the valid duration may be provided/represented by a relative time period (e.g., seconds, minutes, hours, days). The relative time period may inform how long each of the reference locations is valid. The relative time period may be determined by the same as ntn-UlSyncValidityDuration/N, where ntn-UlSyncValidityDuration is described in Table 8 above. For example, the relative time period may be determined based on a value of ntn-UlSyncValidityDuration field divided by a number of the reference locations.

In step S910, the method comprises selecting a reference location, from among the set of reference locations, related to a current time based on the time information.

In some implementations, k-th element in the set may be selected as the reference location based on the current time being larger than or equal to (epoch time+(k−1)*valid time duration) and less than (epoch time+k*valid time duration).

In step S920, the method comprises, based on i) a distance between the wireless device and the reference location and ii) a distance threshold, determining whether to perform neighbor cell measurements. For example, once the wireless device selects one reference location from the set of reference locations, the wireless device may conduct location-based measurement and mobility with selected reference location during relative period.

In some implementations, based on the distance between the wireless device and the reference location being shorter than the distance threshold, it may be determined to perform the neighbor cell measurements.

In some implementations, based on the distance between the wireless device and the reference location being not shorter than the distance threshold, it may be determined not to perform the neighbor cell measurements.

For example, following rules are used by the UE to limit needed measurements:
1> If the serving cell fulfils Srxlev>SIntraSearchP and Squal>SIntraSearchQ:
2> If distanceThresh and referenceLocation are broadcasted in SIB19, and if UE supports location-based measurement initiation and has obtained its location information:
3> If the distance between UE and the serving cell reference location referenceLocation is shorter than distanceThresh, the UE may not perform intra-frequency measurements;
3> Else, the UE shall perform intra-frequency measurements;
2> Else, the UE may not perform intra-frequency measurements;
1> Else, the UE shall perform intra-frequency measurements.
1> The UE shall apply the following rules for NR inter-frequencies and inter-RAT frequencies which are indicated in system information and for which the UE has priority provided:
2> For a NR inter-frequency or inter-RAT frequency with a reselection priority higher than the reselection priority of the current NR frequency, the UE shall perform measurements of higher priority NR inter-frequency or inter-RAT frequencies.
2> For a NR inter-frequency with an equal or lower reselection priority than the reselection priority of the current NR frequency and for inter-RAT frequency with lower reselection priority than the reselection priority of the current NR frequency:
3> If the serving cell fulfils Srxlev>SnonIntraSearchP and Squal>SnonIntraSearchQ:
4> If distanceThresh and referenceLocation are broadcasted in SIB19, and if UE supports location-based measurement initiation and has obtained its UE location information:
5> If the distance between UE and the serving cell reference location referenceLocation is shorter than distanceThresh, the UE may choose not to perform measurements of NR inter-frequency cells of equal or lower priority, or inter-RAT frequency cells of lower priority;
5> Else, the UE shall perform measurements of NR inter-frequency cells of equal or lower priority, or inter-RAT frequency cells of lower priority;
4> Else, the UE may choose not to perform measurements of NR inter-frequency cells of equal or lower priority, or inter-RAT frequency cells of lower priority;
3> Else, the UE shall perform measurements of NR inter-frequency cells of equal or lower priority, or interRAT frequency cells of lower priority.
1> If the UE supports relaxed measurement and relaxedMeasurement is present in SIB2, the UE may further relax the needed measurements.

If the t-Service of the serving cell is present in SIB19, and if UE supports time-based measurement initiation, the UE shall perform intra-frequency, inter-frequency or inter-RAT measurements before the t-Service, regardless of the distance between UE and the serving cell reference location or whether the serving cell fulfils Srxlev>SIntraSearchP and Squal>SIntraSearchQ, or Srxlev>SnonIntraSearchP and Squal>SnonIntraSearchQ, The UE shall perform measurements of higher priority NR inter-frequency or interRAT frequencies regardless of the remaining service time of the serving cell (i.e., time remaining until t-Service).

In some implementations, the wireless device may be in communication with at least one of a mobile device, a network, and/or autonomous vehicles other than the wireless device.

Furthermore, the method in perspective of the wireless device described above in FIG. 9 may be performed by the first wireless device 100 shown in FIG. 2 and/or the UE 100 shown in FIG. 3.

The wireless device comprises at least one transceiver, at least one processor, and at least one memory operably connectable to the at least one processor and storing instructions that, based on being executed by the at least one processor, perform the method described in FIG. 9.

More specifically, the wireless device receives assistance information from a serving cell. The assistance information includes i) a set of reference locations and ii) time information related to each of the reference locations.

In some implementations, the serving cell may be an Earth-moving cell in NTN.

In some implementations, the assistance information may be received per cell. The assistance information may be received via system information containing satellite information for the Earth-moving cell. For example, the assistance information may be received via new system information which defines satellite information for the Earth-moving cell.

In some implementations, the set of reference locations may include N number of reference locations (e.g., reference location 1, reference location 2 . . . reference location N). The reference locations in the set may be sequential in temporal order. Each of the reference locations may have a form of the field same as Ellipsoid-Point, which is described in Table 7 above. For example, each of the reference locations may include at least one of latitudeSign field, degreesLatitude field and/or degreesLongitude field.

In some implementations, the time information related to each of the reference locations may include at least one of an epoch time of each of the reference locations and/or a valid duration.

In some implementations, the epoch time of each of the reference locations may be provided/represented by an absolute time point (e.g., Universal Time Coordinated (UTC)). The absolute time point may inform when each of the reference locations starts to be valid. The absolute time point may be determined by the same as epochTime, which is described in Table 8 above. For example, the absolute time point may be determined based on an epochTime field, which informs a starting time of a DL subframe indicated by SFN and subframe number. After the absolute time point, the wireless device may select one reference location from the set of reference locations.

In some implementations, the valid duration may be provided/represented by a relative time period (e.g., seconds, minutes, hours, days). The relative time period may inform how long each of the reference locations is valid. The relative time period may be determined by the same as ntn-UlSyncValidityDuration/N, where ntn-UlSyncValidityDuration is described in Table 8 above. For example, the relative time period may be determined based on a value of ntn-UlSyncValidityDuration field divided by a number of the reference locations.

The wireless device selects a reference location, from among the set of reference locations, related to a current time based on the time information.

In some implementations, k-th element in the set may be selected as the reference location based on the current time being larger than or equal to (epoch time+(k−1)*valid time duration) and less than (epoch time+k*valid time duration).

The wireless device, based on i) a distance between the wireless device and the reference location and ii) a distance threshold, determines whether to perform neighbor cell measurements. For example, once the wireless device selects one reference location from the set of reference locations, the wireless device may conduct location-based measurement and mobility with selected reference location during relative period.

In some implementations, based on the distance between the wireless device and the reference location being shorter than the distance threshold, it may be determined to perform the neighbor cell measurements.

In some implementations, based on the distance between the wireless device and the reference location being not shorter than the distance threshold, it may be determined not to perform the neighbor cell measurements.

Furthermore, the method in perspective of the wireless device described above in FIG. 9 may be performed by control of the processor 102 included in the first wireless device 100 shown in FIG. 2 and/or by control of the processor 102 included in the UE 100 shown in FIG. 3.

A processing apparatus adapted to control a wireless device comprises at least one processor, and at least one memory operably connectable to the at least one processor. The at least one processor is adapted to perform the method described in FIG. 9.

Furthermore, the method in perspective of the wireless device described above in FIG. 9 may be performed by a software code 105 stored in the memory 104 included in the first wireless device 100 shown in FIG. 2.

The technical features of the present disclosure may be embodied directly in hardware, in a software executed by a processor, or in a combination of the two. For example, a method performed by a wireless device in a wireless communication may be implemented in hardware, software, firmware, or any combination thereof. For example, a software may reside in RAM, flash memory, ROM, EPROM, EEPROM, registers, hard disk, a removable disk, a CD-ROM, or any other storage medium.

Some example of storage medium may be coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include RAM such as Synchronous DRAM (SDRAM), ROM, Non-Volatile RAM (NVRAM), EEPROM, flash memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some implementations of the present disclosure, a non-transitory Computer-Readable Medium (CRM) stores instructions that, based on being executed by at least one processor, perform the method described in FIG. 9.

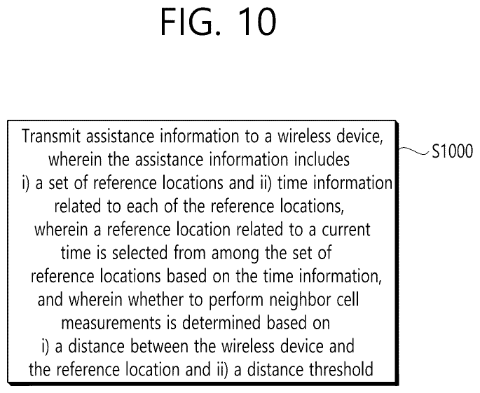

FIG. 10 shows an example of a method performed by a base station to which implementations of the present disclosure are applied.

In step S1000, the method comprises transmitting assistance information to a wireless device. The assistance information includes i) a set of reference locations and ii) time information related to each of the reference locations. A reference location related to a current time is selected from among the set of reference locations based on the time information. Whether to perform neighbor cell measurements is determined based on i) a distance between the wireless device and the reference location and ii) a distance threshold.

Furthermore, the method in perspective of the base station serving a second serving cell described above in FIG. 10 may be performed by the second wireless device 200 shown in FIG. 2.

The base station comprises at least one transceiver, at least one processor, and at least one memory operably connectable to the at least one processor and storing instructions that, based on being executed by the at least one processor, perform the method described in FIG. 10.

More specifically, the base station transmits assistance information to a wireless device. The assistance information includes i) a set of reference locations and ii) time information related to each of the reference locations. A reference location related to a current time is selected from among the set of reference locations based on the time information. Whether to perform neighbor cell measurements is determined based on i) a distance between the wireless device and the reference location and ii) a distance threshold.

The present disclosure may have various advantageous effects.

For example, when the Earth-moving cell serves the UE, the UE can acquire the reference location of the Earth-moving serving cell at a specific time.

For example, the UE can conduct the location-based measurement and CHO based on the reference location of the Earth-moving serving cell.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1-21. (canceled)

22. A method comprising:
receiving assistance information from a serving cell,
wherein the assistance information includes i) a set of reference locations and ii) time information related to each of the reference locations;
selecting a reference location, from among the set of reference locations, related to a current time based on the time information; and
based on i) a distance between a wireless device and the reference location and ii) a distance threshold, determining whether to perform neighbor cell measurements.

23. The method of claim 22, wherein the serving cell is an Earth-moving cell in a Non-Terrestrial Network (NTN).

24. The method of claim 23, wherein the assistance information is received via system information containing satellite information for the Earth-moving cell.

25. The method of claim 22, wherein the reference locations in the set are sequential in temporal order.

26. The method of claim 22, wherein each of the reference locations includes at least one of latitudeSign field, degreesLatitude field and/or degreesLongitude field.

27. The method of claim 22, wherein the time information related to each of the reference locations includes at least one of an epoch time of each of the reference locations and/or a valid duration.

28. The method of claim 27, wherein the epoch time of each of the reference locations is represented by an absolute time point.

29. The method of claim 28, wherein the absolute time point informs when each of the reference locations starts to be valid.

30. The method of claim 28, wherein the absolute time point is determined based on an epochTime field, which informs a starting time of a Downlink (DL) subframe indicated by a System Frame Number (SFN) and a subframe number.

31. The method of claim 27, wherein the valid duration is represented by a relative time period.

32. The method of claim 31, wherein the relative time period informs how long each of the reference locations is valid.

33. The method of claim 31, wherein the relative time period is determined based on a value of ntn-UlSyncValidityDuration field divided by a number of the reference locations,
where ntn-UlSyncValidityDuration field informs a validity duration configured by a network for Uplink (UL) synchronization assistance information which indicates a maximum time during which the wireless device apply assistance information without having acquired new assistance information.

34. The method of claim 22, wherein k-th element in the set is selected as the reference location based on the current time being larger than or equal to (epoch time+(k−1)*valid time duration) and less than (epoch time+k*valid time duration).

35. The method of claim 22, wherein, based on the distance between the wireless device and the reference location being shorter than the distance threshold, it is determined to perform the neighbor cell measurements.

36. The method of claim 22, wherein, based on the distance between the wireless device and the reference location being not shorter than the distance threshold, it is determined not to perform the neighbor cell measurements.

37. The method of claim 22, wherein the wireless device is in communication with at least one of a mobile device, a network, and/or autonomous vehicles other than the wireless device.

38. A wireless device comprising:
at least one transceiver;
at least one processor; and
at least one memory operably connectable to the at least one processor and storing instructions that, based on being executed by the at least one processor, perform operations comprising:
receiving, via the at least one transceiver, assistance information from a serving cell,
wherein the assistance information includes i) a set of reference locations and ii) time information related to each of the reference locations;
selecting a reference location, from among the set of reference locations, related to a current time based on the time information; and
based on i) a distance between a wireless device and the reference location and ii) a distance threshold, determining whether to perform neighbor cell measurements.

39. A base station comprising:
at least one transceiver;
at least one processor; and
at least one memory operably connectable to the at least one processor and storing instructions that, based on being executed by the at least one processor, perform operations comprising:
transmitting, via the at least one transceiver, assistance information to a wireless device,
wherein the assistance information includes i) a set of reference locations and ii) time information related to each of the reference locations,
wherein a reference location related to a current time is selected from among the set of reference locations based on the time information, and
wherein whether to perform neighbor cell measurements is determined based on i) a distance between the wireless device and the reference location and ii) a distance threshold.
